(19) United States
(12) Patent Application Publication
(10) Pub. No.: US 2008/0060290 A1
(43) Pub. Date: Mar. 13, 2008

(54) Thermally Efficient Window Frame

(75) Inventors: Timothy B. McGlinchy, Twinsburg, OH (US); Robert R. Shepherd, Mogadore, OH (US); William A. Briese, Hinckley, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: GED Integrated Solutions, Inc., Twinsburg, OH (US)

(21) Appl. No.: 11/778,719

(22) Filed: Jul. 17, 2007

Related U.S. Application Data
(60) Provisional application No. 60/832,923, filed on Jul. 24, 2006.

(51) Int. Cl. E06B 3/67

(52) U.S. Cl. 52/204.593; 52/745.19

(57) ABSTRACT

Method and Apparatus for fabricating a spacer frame for use in an insulating glass unit. A spacer frame separates spaced apart window panes in an insulating glass unit for use in fabricating a window The spacer includes an elongated frame that is bent into a multi-sided closed form having outwardly facing surfaces for supporting the spaced window panes. An intermediate or bridging body portion of the frame transmits heat between the spaced window panes. Thermal interruptions in this intermediate body portion disrupt heat flow to raise the inside window temperature in winter and lower it in summer. This is referred to as the warm edge value. A thermal insulating film material preferably covers at least a portion of the intermediate body portion and covers the thermal interruptions

### CROSS REFERENCE TO RELATED APPLICATION

The present application claims priority from provisional U.S. Patent application Ser. No. 60/832,923 entitled “Thermally Efficient Window Frame” filed Jul. 24, 2006 and whose contents are incorporated by Reference.

### FIELD OF THE INVENTION

The present invention relates to insulating glass units and more particularly to a thermally efficient window frame.

### BACKGROUND OF THE INVENTION

Insulating glass units (IGUs) are used in windows to reduce heat loss from building interiors during cold weather, IGUs are typically formed by a spacer assembly sandwiched between glass lites. A spacer assembly usually comprises a frame structure extending peripherally about the unit, a sealant material adhered both to the glass lites and the frame structure, and a desiccant for absorbing atmospheric moisture within the unit. The margins of the glass lites are flush with or extend slightly outwardly from the spacer assembly. The sealant extends continuously about the frame structure periphery and its opposite sides so that the space within the IGUs is hermetic.

One successful IGU construction has employed tubular, roil formed aluminum or steel frame elements connected at their ends to form a square or rectangular spacer frame. The frame sides and corners were covered with, sealant (e.g., a hot melt material) for securing the frame to the glass lites. The sealant provided a harrier between atmospheric air and the IGU interior which blocked entry of atmospheric water vapor. Particulate desiccant deposited inside the tubular frame elements communicated with air trapped in the IGU interior to remove the entrapped airborne water vapor and thus preclude its condensation within the unit. Thus after the water vapor entrapped in the IGU was removed internal condensation only occurred when the unit failed.

Alternatively, individual roll formed spacer frame tubes were cut to length and “corner keys” were inserted between adjacent frame element ends to form the corners. In some constructions the corner keys were foldable so that the sealant could be extruded onto the frame sides as the frame moved linearly past a sealant extrusion, station. The frame was then folded to a rectangular configuration with the sealant in place on the opposite sides. The spacer assembly thus formed was placed between glass lites and the IGU assembly completed.

U.S. Pat. No. 5,361,476 to Leopold discloses a method and apparatus for making IGUs wherein a thin flat, strip of sheet material is continuously formed into a channel shaped spacer frame having corner structures and end structures, the spacer thus formed is cut off, sealant and desiccant are applied and the assemblage is bent to form a spacer assembly.

Published United States patent application no. 2001:0032436 to Riegelman entitled “Insulated Channel Seal for Glass Panes” concerns structure having a channel for a frame which separates window panes to form an insulated window has a plurality of openings through a wall of the channel that faces outward along the periphery of the frame and glass sandwich. The openings are designed to prevent significant passage of sealant from the outside of the channel to the inside of the channel through the openings. This is done by the cross sectional area of each opening being so small that it resists viscous flow of the sealant through the opening, or by a cover over the opening. Edgetech and Nynex produce all pvc window spacer frames having thermally efficient insulating characteristics.

U.S. Pat. No. 6,131,364 to Peterson relates to a “Spacer for Insulated Windows Having a Lengthened Thermal Path” and describes a spacer frame bar that has spaced, staggered sequences of longitudinally oriented elongated slits which increase the length of the thermal conductivity path from the first pane to the second.

### SUMMARY

A spacer frame for separating spaced apart window panes in an insulating glass unit for use in fabricating a window The spacer includes an elongated frame having a multi-sided form having outwardly facing surfaces for supporting the spaced window panes. An intermediate or bridging body portion of the frame transmits heat between the spaced window panes. Thermal interruptions in this intermediate body portion disrupt heat flow to raise the inside window temperature in winter and lower it in summer. This is referred to as the warm edge value. A thermal insulating material preferably covers at least a portion of the intermediate body portion and covers the thermal interruptions. These and other advantages and features are described in more detail below.

### BRIEF DESCRIPTION OF THE DRAWINGS

FIG. 1 is a perspective view of an insulating glass unit;

FIGS. 2 and 3 are top and side views of a spacer frame that forms part of the FIG. 1 insulating glass unit;

FIG. 4 is an elevation depiction of a production line for use with the invention;

FIGS. 5 and 6 are perspective and plan view of one embodiment of the invention;

FIG. 7 is a plan view of an alternate embodiment of the Invention;

FIG. 8 is a section view of one embodiment of the invention;

FIG. 9 is a plan view of the FIG. 8 frame showing pattern of thermal interruptions in a wall of the frame used in a thermal transfer model;

FIG. 10 is a view from the plane defined by the line 10-10 in FIG. 9;

FIG. 11 is a view of use of a thermal barrier in a region of a spacer frame corner;

FIG. 12 is a view of use of a thermal barrier in a region of a connecting tab; and

FIGS. 13A-13K illustrate alternate embodiments of spacer frame thermal barrier designs.

### EXEMPLARY EMBODIMENT OF THE INVENTION

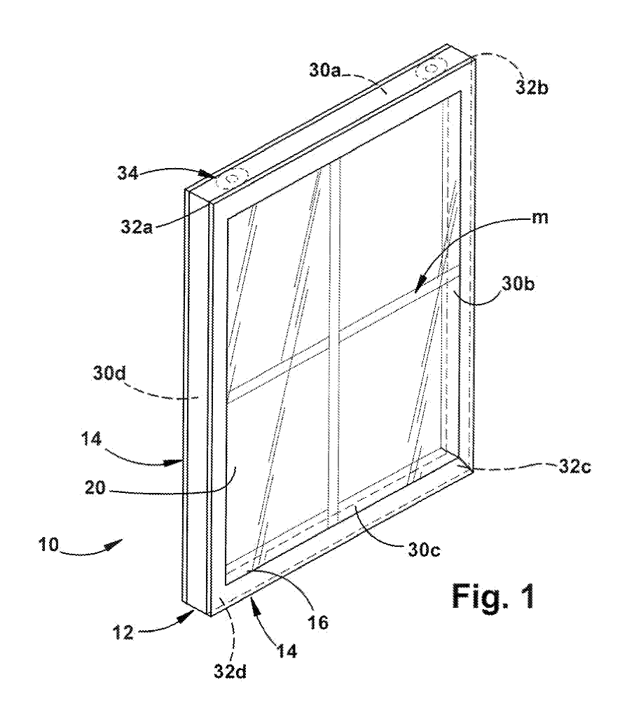

An insulating glass unit (IGU) 10 is illustrated in FIG. 1. The IGU includes a spacer assembly 12 sandwiched between glass sheets, or lites, 14. The assembly 12 comprises a frame structure 16 and sealant material for hermetically joining the frame to the lites to form a closed space 20 within the unit 10. The unit 10 is illustrated in FIG. 1 as in condition for final assembly into a window or door frame, not illustrated, for ultimate installation in a building. The unit 10 illustrated in FIG. 1 includes muntin bars that provide the appearance of individual window panes.

The assembly 12 maintains the lites 14 spaced apart from each other to produce the hermetic insulating “insulating air space” 20 between them. The frame 16 and the sealant body 18 co-act to provide a structure which maintains the lites 14 properly assembled with the space 20 sealed from atmospheric moisture over long time periods during which the unit 10 is subjected to frequent significant thermal, stresses. A desiccant 19 removes water vapor from air, or other volatiles, entrapped in the space 20 during construction of the unit 10.

The sealant both structurally adheres the lites 14 to the spacer assembly 12 and hermetically closes the space 20 against infiltration of airborne water vapor from the atmosphere surrounding the unit 10. One suitable sealant is formed from a “hot melt” material which is attached to the frame sides and outer periphery to form a U-shaped cross section.

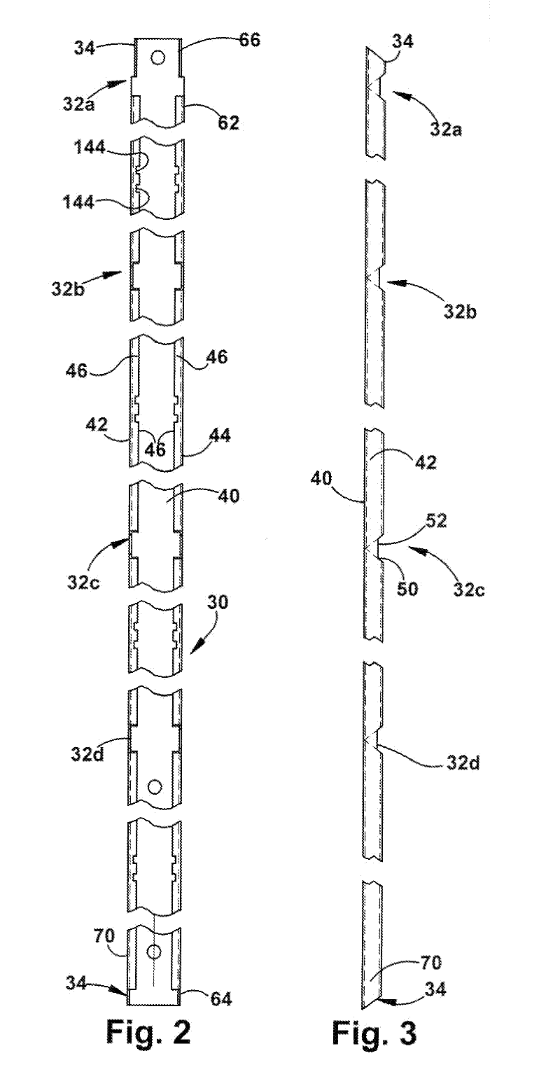

The frame 16 extends about the unit periphery to provide a structurally strong, stable spacer for maintaining the lites aligned and spaced while minimizing heat conduction between the lites via the frame. The preferred frame 16 comprises a plurality of spacer, frame segments, or members, 30a-d connected to form a planar, polygonal frame shape, element juncture forming frame corner structures 32a-d, and connecting structure 34 (FIG. 2) for joining opposite frame element ends to complete the closed frame shape.

Each frame member 30 is elongated and has a channel shaped cross section defining a peripheral wall 40 and first and second lateral walls 42, 44. See FIG. 2, The peripheral wall 40 extends continuously about the unit 10 except where the connecting structure 34 joins the frame member ends. The lateral walls 42, 44 are integral with respective opposite peripheral wall edges. The lateral walls extend inwardly from, the peripheral wall 40 in a direction parallel to the planes of the lites and the frame. The illustrated frame 16 has stiffening flanges 46 formed along the inwardly projecting lateral wall edges. The lateral wails 42, 44 add rigidity the frame member 30 so it resists flexure and bending in a direction transverse to its longitudinal extent. The flanges 46 stiffen the walls 42, 44 so they resist bending and flexure transverse to their longitudinal extents.

The frame is initially formed as a continuous straight channel constructed from a thin ribbon of stainless steel material (e.g., 304 stainless steel having a thickness of 0.006-0.010 inches). Other materials, such as galvanized, tin plated steel, aluminum or plastic, may also be used to construct the channel. As described more fully below, the corner structures 32 are made to facilitate bending the frame channel to the final, polygonal frame configuration in the unit 10 while assuring an effective vapor seal at the frame corners. A sealant is applied and adhered to the channel before the corners are bent. The corner structures 32 initially comprise notches 50 and weakened zones 52 formed in the walls 42, 44 at frame corner locations. See FIGS. 3-6. The notches 50 extend into the walls 42, 44 from the respective lateral wail edges. The lateral walls 42, 44 extend continuously along the frame 16 from one end to the other. The walls 42, 44 are weakened at the corner locations because the notches reduce the amount of lateral wall material and eliminate the stiffening flanges 46 and because the walls are punched and stamped to weaken them at the corners.

At the same time the notches 50 are formed, the weakened zones 52 are formed. These weakened zones are cut into the strip, but not all the way through. When this strip is rollformed, the weakened zones can spring back and have an outward, tendency.

The connecting structure 34 secures the opposite frame ends 62, 64 together when the frame has been bent to its final configuration. The illustrated connecting structure comprises a connecting tongue structure 66 continuous with and projecting from the frame structure end 62 and a tongue receiving structure 70 at the other frame end 64. The preferred tongue and tongue receiving structures 66, 70 are constructed and sized relative to each other to form a telescopic joint. When assembled, the telescopic joint 72 maintains the frame in its final polygonal configuration prior to assembly of the unit 10.

### The Production Line 100

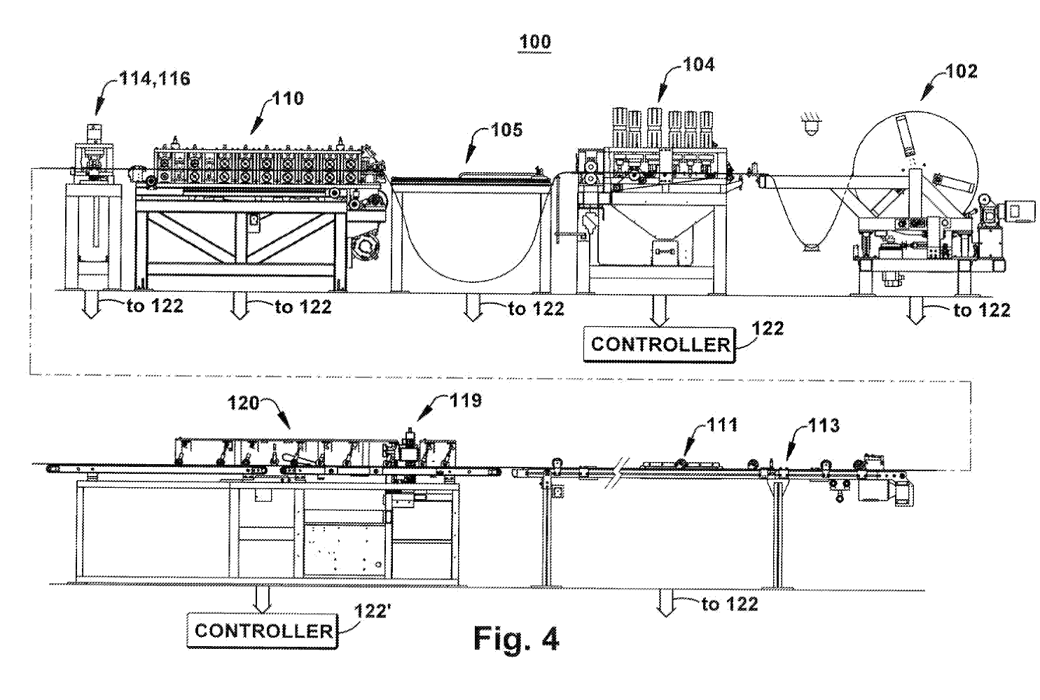

An operation by which elongated window components are made is schematically illustrated in FIG. 4 as a production line 100 through which a thin, relatively narrow ribbon of sheet metal stock is fed endwise from a coil into one end of the assembly line and substantially completed elongated window components 8 emerge from the other end of the line 100.

The line 100 comprises a stock supply station 102, a first forming station 104, a transfer mechanism 105, a second forming station 110, a conveyor 113, a scrap removal apparatus 111, third and fourth forming stations 114, 116, respectively, where partially formed spacer members are separated from the leading end of the stock and frame corner locations are deformed. At a desiccant application station 119 desiccant is applied to an interior region of the spacer frame member, and at an extrusion station 120 sealant is applied to the yet to be folded frame member. A scheduler/motion controller unit 122 interacts with the stations and loop feed sensors to govern the spacer stock size, spacer assembly size, the stock feeding speeds in the line, and other parameters involved in production. A preferred controller unit 122 is commercially available from Delta Tau, 21314 Lassen St, Chatsworth, Calif. 91311 as part number UMAC. In one embodiment a separate conotroller 122′ controls the desiccant application and adhesive or sealant application. Additional details of a representative spacer frame fabrication system are contained in published US application no. 2006:0075719-A1 which is incorporated herein by reference.

### Thermal Barrier

In an exemplary embodiment of the invention the spacer frame 10 enhances the thermal properties of the resulting window by disrupting or interrupting thermal, energy flow of energy from one side of the wall to the other of the installed window. This raises the temperature of the window's inwardly facing edge in winter by impeding heat flow from inside the home or other building.

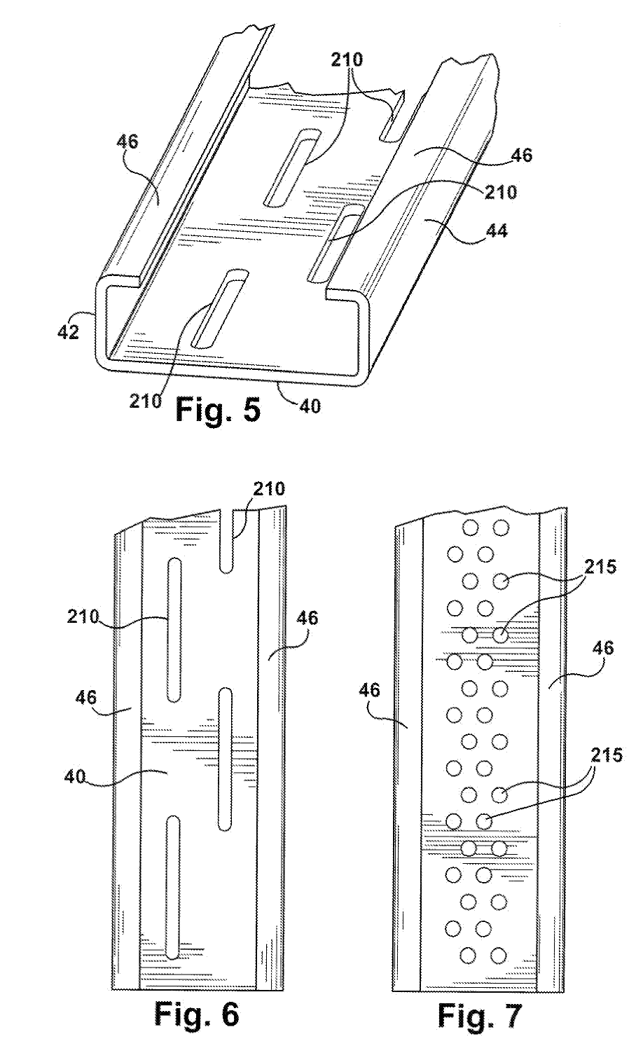

In the exemplary embodiment, this heat flow disruption is accomplished by punching or otherwise forming elongated thermal interruptions 210 in the metal of the peripheral wall 40 of fee frame, in the disclosed exemplary embodiment, the interruptions are slots or voids. These interruptions disrupt heat transfer across the wall from one side wall 42 to the opposed side wall 44 but do not unduly interrupt the structural integrity of the wall 40. The embodiment depicted in FIGS. 5 and 6 has two side by side arrays of slots that extend in an overlapping fashion. This design preserves strength while increasing the conduction path between the panes to gain a higher warm edge value.

An alternate method illustrated in FIG. 7 interrupts the spacer's conductivity path in away that also reduces the risk of the desiccated matrix 19 seeping through the spacer 10 dining application of desiccant at the station 119. This may be required if the desiccated matrix is heated during and applied within the manufacturing process. In this regard the illustration of FIG. 7 shows a regular array of holes 215 that form thermal interruptions.

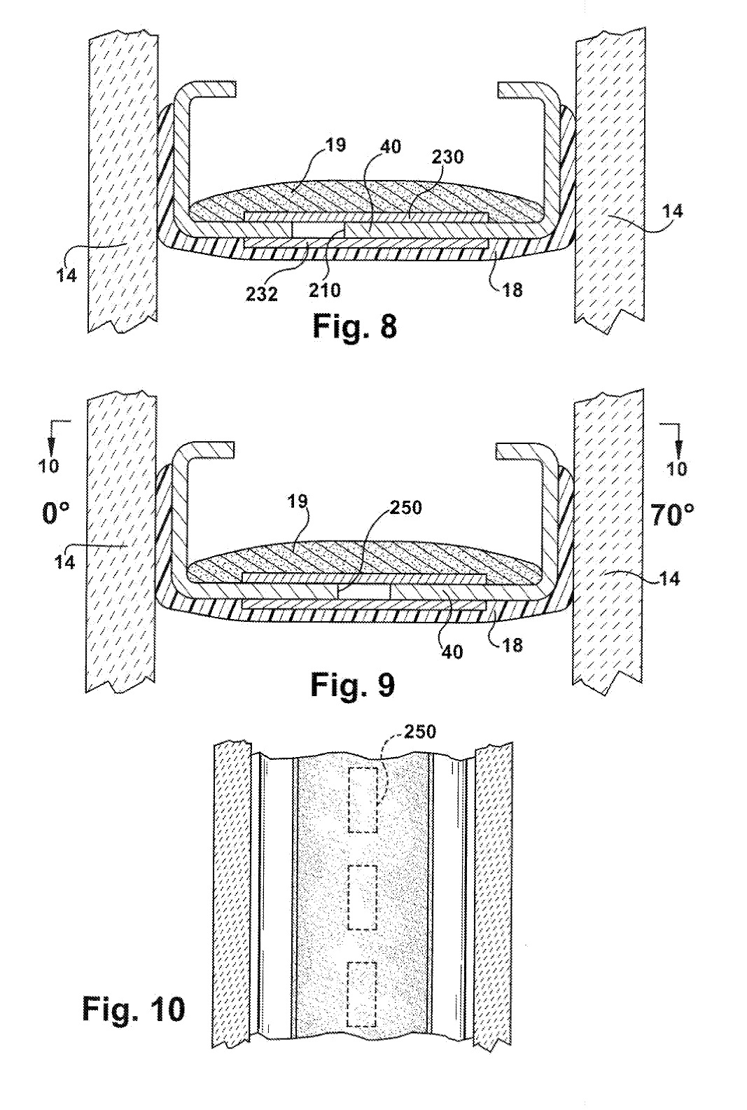

to the cross section view of FIG. 8 illustrates the spacer 10 having an adhesive 18 and desiccant 19 in place wherein the interruptions 210 are covered on both sides of the wall 40 with strips of low MVTR barrier film 230, 232 that are applied longitudinally along the linear extent of the frame. MVTR is shorthand for “moisture vapor transition rate”.

### Thermal Analysis

Although the patterns that make up the interruption can vary, one can simulate the value of this spacer system by performing a thermal analysis. FIG. 9 illustrates an IG unit that is subjected to boundary temperature of 0 degrees F. outside and 70 degrees F. inside. These are typical temperature boundary conditions used in the Window and Door Industry to compare performance of different insulated glass spacer designs.

In this example of FIG. 9, the model simulated is a metal strip and the thermal interruptions are rectangular slots 250 that are equally spaced down the middle of the strip. The duty cycle between the spaced apart slots 250 is controllable to control the thermal characteristics. Stated another way, the proportion of air to metal makeup along the center line is controlled so that for example, one half steel and one half air (50% duty cycle) could by chosen by proper slot spacing and slot length. One illustrative example uses 0.010″ tin plate coated steel as the spacer frame with a thin (2 or 3 thousands thick) mylar films 230, 232 on both sides of the frame to provide a MVTR barrier. Two cross sections were modeled to understand heat transfer through the spacer frame unit of FIG. 9. The pattern that can be put into the spacer can be many permutations of this basis pattern. A second cross section is modeled is a path through the metal.

The thermal interruption 250 was modeled with a 0.120 inch wide air gap. In a first thermal transfer calculation through the frame, no slot is present so that the steel frame transmits higher amounts of heat. Through the air gap defined by the slot 250 a predicted temperature is about 45 degrees. These calculations are based on thermal conductivity of air of 0.003 Watts/m deg K and tin plate steel of 50.0 Watts/m deg K. These calculations are made more complex by the presence of desiccant (thermal conductivity 0.13) and sealant or adhesive (thermal conductivity 0.24) and film material (thermal conductivity 0.24 Watts/m deg K) of polyester film.

The thin film layers 230, 232 applied to the exterior and/interior of the unit in order to create a seal to keep the moisture out of the completed IGU. These thin film layers have the characteristics of having low MVTR properties in order to keep moisture out of the sealed IG unit over time. The desiccated matrix 19 is also applied to the interior of the unit to absorb moisture from the air that is initially sealed in the IG unit when it is constructed, as well as any moisture that penetrates the sealed perimeter over time through the sealant 18.

Examples of products that can be used as film 230, 232 include mylar, or 3M's P Model #850 Polyester film. This product has a sputtered metal barrier, and can be applied around the perimeter of the unit before folding the frame into a rectangle. The tap stretches around the corners as the frame is bent. Other 3M products deemed suitable are their ‘Very Low Outgassing High Shear Polyester Tape’ sold as model 8439, ‘Low Outgassing Polyester Tape’ sold under model number 8333, ‘Very Low Outgassing Linered Polyester Tape’ sold as model number 6690, and ‘Aluminum Foil Tape’ sold as model number 431 or 439L (Linered). The product specification sheets of these film materials are incorporated herein by reference.

In one illustrated embodiment, the thermal interruption is formed by holes 215 or notches 210 created with either with a punch or with a laser downstream from the roil former but before cutoff. Film is applied to the raw strip material used to fabricate the spacer frame after it has been punched, or just prior to or just after the roll forming of the spacer frame to form the lateral walls 42, 44 and the flange 46, or after cutoff of the frame from the continuous supply.

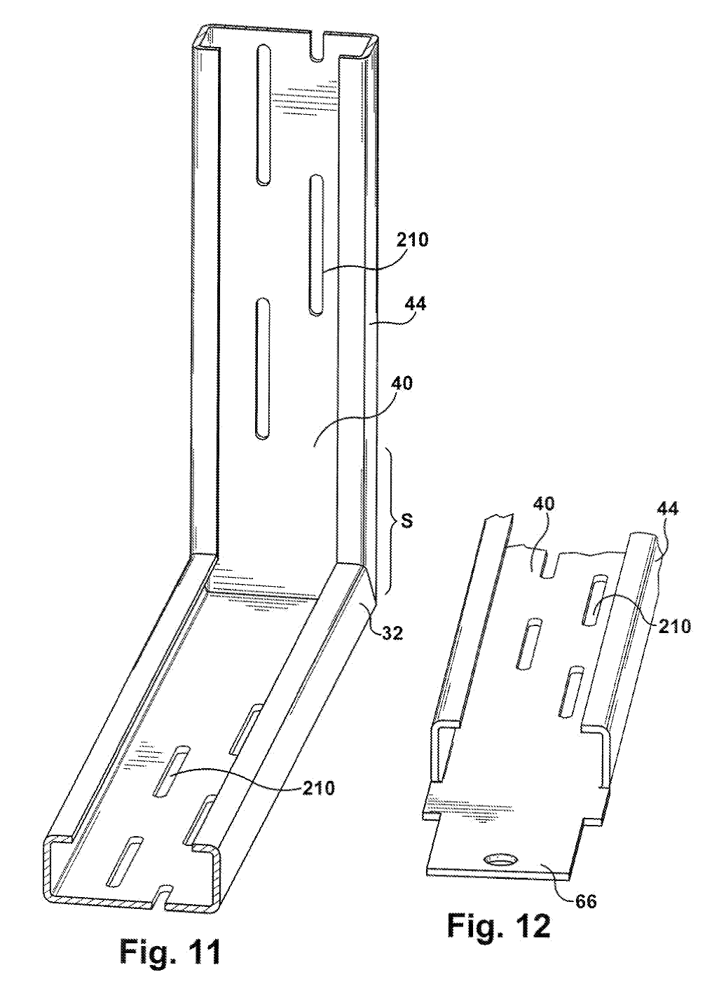

FIGS. 11 and 12 illustrate the use of notches 210 in a region of a corner 32 and the region of the tongue structure 66. To maintain the structural integrity of the corner and the tongue for connecting the spacer frame ends once they are cut, a length (S) of about one inch is free of notches in these depictions. The one inch length is representative and other lengths are certainly within the scope of the invention.

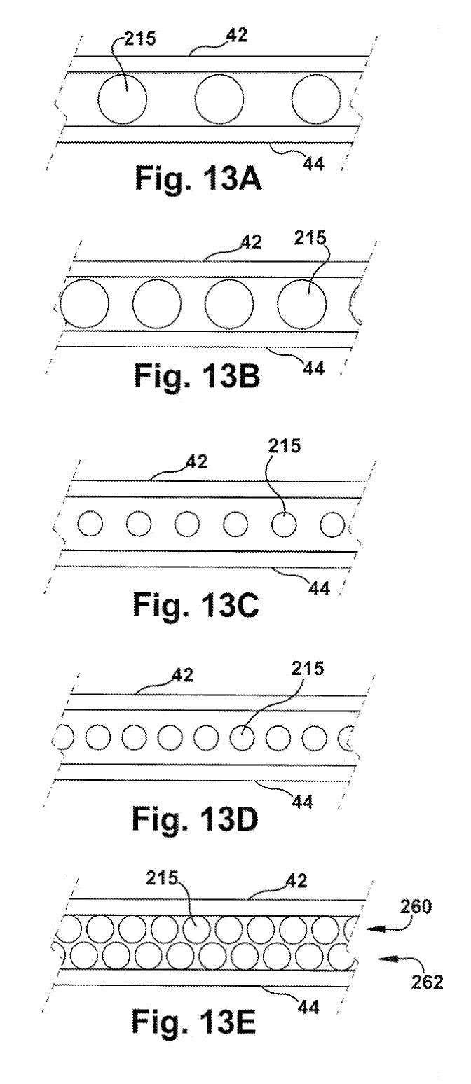

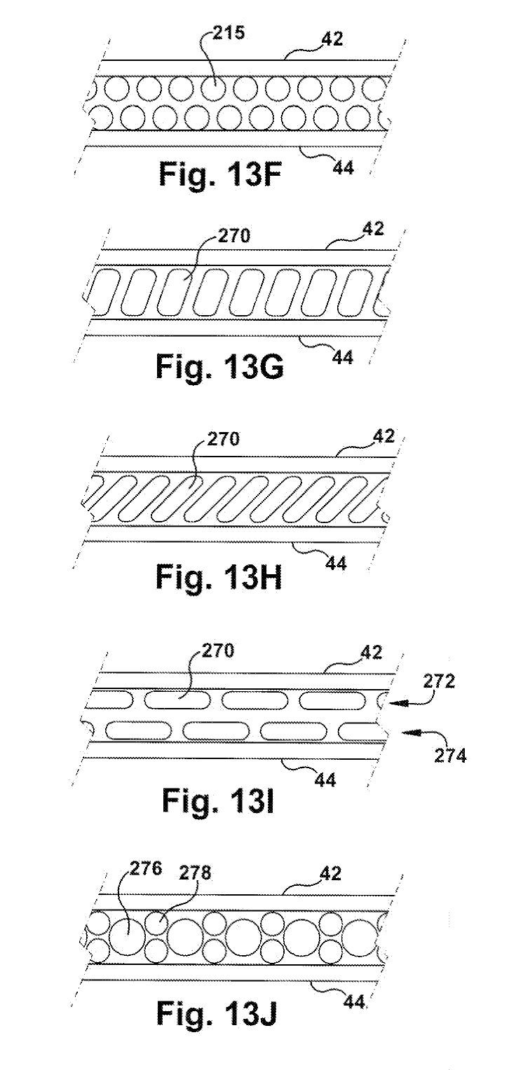

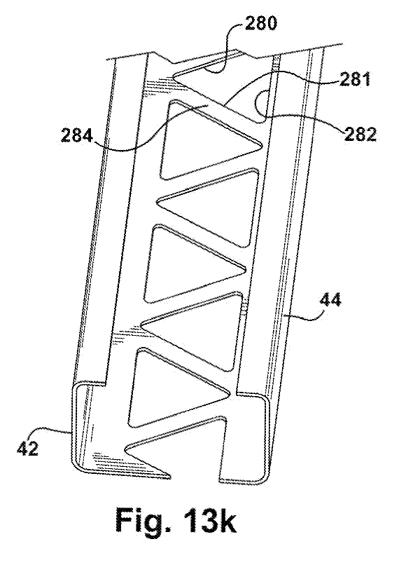

The alternate depictions, of FIGS. 13A-13J illustrate thermal interruption configurations formed in the metal to increase the thermal insulating properties of the spacer frame. FIGS. 13A and 13B illustrate control over those properties by varying the spacing between adjacent centered holes 215 formed in the frame's peripheral wall 40.

FIGS. 13 C and 13 D show smaller holes 215 and again show different gaps or spaces between regularly spaced holes 215 formed along the center line of the wall 40.

In FIGS. 13E and 13 F the wall has two rows 260, 262 of holes 215 having different diameter so that the spacing between holes is controlled.

In FIGS. 13G, 13h and 13I, the wall 40 is disrupted by slots 270 with rounded corners having controlled widths. In FIGS. 13G and 13H the slots have center lines that are angled at different acute angels with respect the two generally parallel side walls 42, 44 of the frame. In FIG. 131, the slots 270 have centerlines that extend generally parallel to the walls 42, 44 in two elongated rows 272, 274.

FIG. 13 J illustrates a spacer frame wherein the thermal properties are controlled by holes 276, 278 of different diameter spaced with respect to each other to achieve desired structural integrity and enhanced thermal disruption of heat, flow across fee frame.

FIG. 13 K the thermal interruptions have three sides 280, 281, 282, to form triangular voids. Angled cross pieces 284 separate adjacent triangular voids along the length of the spacer and as stated above, regions near corners or connecting tongues of the spacer are left intact without voids.

While an exemplary embodiment of the invention has been described with particularity, it is the intent that the Invention include all modifications from the exemplary embodiment falling within the spirit or scope of the appended claims.

1. Apparatus for fabricating a spacer frame for use in an insulating glass unit comprising:
a) forming structure for forming a spacer frame having side walls to which an adhesive is applied during fabrication of an insulated glass unit and a bridging or intermediate wall that extends between the side walls;
b) apparatus for forming thermal interruptions at locations that extend through the bridging wall to change the heat transfer characteristics of the spacer frame; and
c) a workstation for applying film over the notches.

2. The apparatus of claim 1 wherein the film is applied over the thermal interruptions subsequent to separation of a spacer frame from a source of material from which the spacer frame is formed.

3. The apparatus of claim 1 wherein the film is applied over the thermal interruptions on at least one side of the spacer frame.

4. The apparatus of claim 1 wherein the film is applied over the thermal interruptions on both sides of the spacer frame.

5. The apparatus of claim 1 wherein the thermal interruptions are spaced apart by sections of the bridging wall having a predetermined length.

6. The apparatus of claim 1 wherein the thermal interruptions are formed in metal walls of the spacer frame formed by punching with a rotating die.

7. The apparatus of claim 1 wherein the thermal interruptions are formed by a laser or a gang punch through metal walls of the spacer frame.

8. A spacer for separating first and second window panes from each other in an insulating glass unit for use in fabricating a window comprising:
an elongated frame forming a multi-sided form having outwardly facing surfaces for supporting the first and second window panes that are bridged by an intermediate wall portion of the frame that transmits heat between fee first and second window panes; and
a thermal insulating material covering at least a portion of the intermediate body portion;
wherein the intermediate wall portion includes thermal interruptions covered by the thermal insulating material for disrupting heat flow between said outwardly facing surfaces.

9. The spacer of claim 8 wherein the thermal insulating material covers both surfaces of the intermediate wall.

10. The spacer of claim 8 wherein a spacing between thermal interruptions in the intermediate wall is controlled to provide a duty cycle of a specified amount.

11. The spacer of claim 8 wherein the thermal interruptions form triangular openings extending through a wall of the spacer.

12. A process of forming a supply of material for fabrication into a spacer frame by bending with a roll former comprising:
providing an elongated supply of material that is flexible enough to be wound on a roll and for use in creating spacer frames;
creating thermal interruptions along the length of the material at controlled locations to adjust the thermal conductivity of the width of said material; and
winding the material onto a roll to provide a source of said material for unwinding and routing through an automated spacer frame machine.

13. The spacer of claim 8 wherein fee multisided form of said frame includes corners and to maintain the structural integrity of the frame in a region of a corner the thermal interruptions are spaced away from the corners a specified distance.

14. The spacer of claim 8 wherein the frame includes a connecting tab and to maintain the structural integrity of the frame in a region of the tab the voids are spaced away from the tab a specified distance.

15. The spacer of claim 8 wherein the frame is disrupted by similarly shaped thermal interruptions spaced along a centerline of said frame at controlled distances from each other.

16. The spacer of claim 8 wherein the thermal interruptions are generally circular in plan and a diameter of the generally circular thermal interruptions is adjusted to control the thermal conducting properties of the frame.

17. The spacer of claim 8 wherein the thermal interruptions are arranged in side by side rows extending along a section of the spacer frame.

18. The spacer of claim 17 wherein the thermal interruptions within a single frame have different dimensions or areas.

19. the spacer of claim 18 wherein the thermal interruptions are generally circular and have different diameter.

20. The spacer of claim 8 wherein the thermal interruptions are slots with rounded corners, said slots having controlled widths.
